(19) United States
(12) Patent Application Publication
(10) Pub. No.: US 2006/0238500 A1
(43) Pub. Date: Oct. 26, 2006

(54) Dual configuration portable electronic apparatus

(76) Inventors: Leonid Olshansky, Brooklyn, NY (US); Yevgeniy Zeltser, Brooklyn, NY (US)

Correspondence Address: Rdward Etkin, Esq.;Law Office of Edward Etkin, Esq., PC, Suite A, 228 West End Avenue, Brooklyn, NY, 11235, US

(21) Appl. No.: 11/358,350

(22) Filed: Feb. 18, 2006

Related U.S. Application Data
(60) Provisional application No. 60/673,550, filed on Apr. 21, 2005.

(51) Int. Cl. G09G 5/00

(52) U.S. Cl. 345/156

(57) ABSTRACT

The inventive apparatus is an electronic apparatus (e.g., remote control unit, PDA, computer, etc.) having two sections, each with an interface surface facing the user disposed at an (optionally adjustable) angle to one another. The interface surfaces may include one or more buttons, touchpads, screens, dials, joysticks, touchscreens, or any combination thereof. The two sections are connected by a grasp element that includes a groove on the interface surface side for receiving one of the user's fingers when the apparatus is held during operation thereof, and a back portion for contact with user's other fingers/palm. Optionally, the back portion is also configured to serve as a support if the unit is placed on a tabletop or other surface. The novel apparatus may thus be readily held by the user in one hand by placing a finger of the holding hand into the groove and cupping the back portion with the rest of the hand. The user may then freely interact with the interface surfaces using the other hand. Advantageously, the inventive apparatus may be readily utilized by both right and left-handed users.

### CROSS REFERENCE TO RELATED APPLICATION

The present patent application claims priority from the commonly assigned U.S. provisional patent application No. 60/673,550) entitled “DUAL CONFIGURATION PORTABLE ELECTRONIC APPARATUS” filed Apr. 21, 2005.

### FIELD OF THE INVENTION

The present invention relates generally to hand-held electronic devices, and more particularly to portable ergonomic electronic devices for performing one or more functions that are comfortable to hold and operate.

### BACKGROUND OF THE INVENTION

In recent years electronic devices and systems of all sorts have taken the world by storm. Devices ranging from portable media players and PDAs, to computers and complex home entertainment and automation systems, have become a part of everyone's daily routines.

However, the growth in the number and complexity of different electronic devices and systems resulted in a geometric increase in the difficulties associated with interaction with, and control thereof. With each device and system requiring its own set of controls and information displays, all but the most savvy of users become quickly overwhelmed by the sheer amount of different control devices and interfaces, not to mention the various control and interface information they would need to remember.

Accordingly, addressing the “user interface” challenge has been one of the foremost goals of the various electronic (computer, e.g.) device and system designers and manufacturers. One of the key developments in control devices and portable electronic devices (PDAs, media players, etc.) has been the introduction of flat screen displays as part of the user interface. In recent years, the displays in such devices additionally offer input features, such as touchscreens, that enable the user to issue commands by interacting with the displays (via their finger or a stylus). In every case, additional physical controls (buttons, etc.) are provided on the device for navigating the user interface, for issuing the commands, and/or for programming by the user.

Portable electronic devices can be generally separated into three broad categories—(1) devices that have self-contained capabilities (such as media players, communication devices, etc.); (2) devices that are primarily configured for controlling other systems or components (such as controls for operating home and/or facility automation systems); and (3) devices that are capable of both self-contained functionality, and also capable of interacting with and controlling other systems.

As the capabilities of these devices have increased, there has been a significant trend in providing various electronic devices with screens having a touch and/stylus interaction functionality. Naturally, larger screens allow a greater degree of interaction with the device itself (for category 1 and 3 devices) and/or with components which the device is intended to control (for category 2 and 3 devices).

Accordingly, most of the portable devices of the above three categories are sized and configured to be held in both hands during use, some of the devices are intended for tabletop use, and certain devices are configured to be utilized as both handheld and tabletop units. Notwithstanding attempts to increase the ergonomics of device cases, the size, shape, and weight distribution of most previously known devices, prevent the users from easily holding them in one hand. In attempting to do so, the users inevitably experience a difficulty in simultaneously holding a device and interacting with it. In addition, devices configured for hand-held use are often supplied with cradles (in many cases including battery charging features) that make the devices difficult to use while placed therein.

The ergonomics and user interface interaction issues are particularly crucial for extended use electronic devices, for example category 1 devices that typically involve lengthier user interaction sessions, such as media players, PDAs, and hand-held electronic game systems. In such cases the manner in which the user must physically hold and interact with the device being utilized is of paramount importance. Finally, most portable electronic devices are static in configuration, and cannot be adjusted in any way in response to user's ergonomic requirements.

It would be desirable to provide an interactive electronic apparatus, that while sizeable, enables a user to easily hold it in one hand, while using the other hand, or both hands to interact with it. It would also be desirable to provide an electronic apparatus that is readily capable of being ergonomically utilized in both hand-held and table-top modes. It would further be desirable to provide an interactive electronic apparatus having adjustable multiple ergonomic physical configurations.

### BRIEF DESCRIPTION OF THE DRAWINGS

In the drawings, wherein like reference characters denote corresponding or similar elements throughout the various figures:

FIG. 1A is a schematic diagram showing a cross-section side view of a first exemplary embodiment of the inventive apparatus;

FIG. 1B is a schematic diagram showing a top-down front view of the inventive apparatus of FIG. 1A;

FIG. 2A is a schematic diagram showing a cross-section side view of an alternate exemplary embodiment of the inventive apparatus of FIGS. 1A and 1B

FIG. 2B is a schematic diagram showing an isometric view of the inventive apparatus of FIG. 2A

FIG. 3A is a schematic diagram showing a cross-section side view of a second exemplary embodiment of the inventive apparatus;

FIG. 3B a schematic diagram showing a cross-section side view of a first alternate exemplary embodiment of the inventive apparatus of FIG. 3A;

FIG. 3C a schematic diagram showing a cross-section side view of a alternate exemplary embodiment of the inventive apparatus of FIG. 3B;

FIG. 4A is a schematic diagram showing a cross-section side view of a third exemplary embodiment of the inventive apparatus;

FIG. 4B is a schematic diagram showing a top-down front view of the inventive apparatus of FIG. 4A;

FIG. 5A is a schematic diagram showing a cross-section side view of a fourth exemplary embodiment of the inventive apparatus;

FIG. 5C is a schematic diagram showing a cross-section side view of an alternate configuration of the inventive apparatus of FIG. 6A;

FIG. 6 is a schematic diagram showing a cross-section side view of a fifth exemplary embodiment of the inventive apparatus; and

FIGS. 7A to 7D are schematic diagrams showing a cross-section side views of various alternate embodiments of the inventive apparatus of FIG. 1.

### SUMMARY OF THE INVENTION

The present invention is directed to an electronic apparatus (e.g., remote control unit, PDA, media player, game device, computer, etc.) having at two sections, each with an interface surface facing the user disposed at an (optionally adjustable) angle to one another. The interface surfaces may include one or more interface elements such as buttons, touchpads, screens, dials, joysticks, touchscreens, or any combination thereof. The two sections are connected by a grasp element that includes a groove on the interface surface side for receiving one of the user's fingers when the apparatus is held during operation thereof, and a back portion for contact with user's other fingers/palm. Optionally, the back portion is also configured to serve as a support if the unit is placed on a tabletop or other surface. The novel apparatus may thus be, readily held by the user in one hand by placing a finger of the holding hand into the groove and cupping the back portion with the rest of the hand. The user may then freely interact with the interface surfaces using the other hand. Advantageously, the inventive apparatus may be readily utilized by both right-and left-handed users. Alternate embodiments of the inventive apparatus include interface elements positioned within the grasp element, as well as various configurations of the device sections.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EXEMPLARY EMBODIMENTS

The inventive apparatus of the present invention addresses the ergonomic and other user-interface challenges of previously known electronic devices, by providing a two section device, with at least one section including at least one interface element, and having a novel grasp element therebetween that serves the dual purpose of enabling the user to easily hold the device in one hand while operating it with another, and optionally may include a base that enables the device to be used in a tabletop configuration (for example in connection with a tabletop holding element).

In summary, the inventive apparatus is an electronic apparatus (e.g., remote control unit, PDA, computer, etc.) having two sections, with at least one of the sections having an interface surface facing the user, that are disposed at an (optionally adjustable) angle to one another. The interface surfaces may include one or more interface elements such as buttons, touchpads, screens, dials, joysticks, touchscreens, or any combination thereof. The two sections are connected by a grasp element that includes a groove-like receiving region on the interface surface side of the device for receiving one of the user's fingers when the device is held during operation thereof, and a back portion for contact with user's other fingers/palm. Optionally, the back portion is also configured to serve as a support if the unit is placed on a tabletop or other surface (in itself or in connection with a holding element. The novel apparatus may thus be readily held by the user in one hand by placing a finger of the holding hand into the receiving region and cupping the back portion of the device with the rest of the hand. The user may then freely interact with the interface surface(s) using the other hand. Furthermore, the inventive apparatus may be readily utilized by both right- and left-handed users.

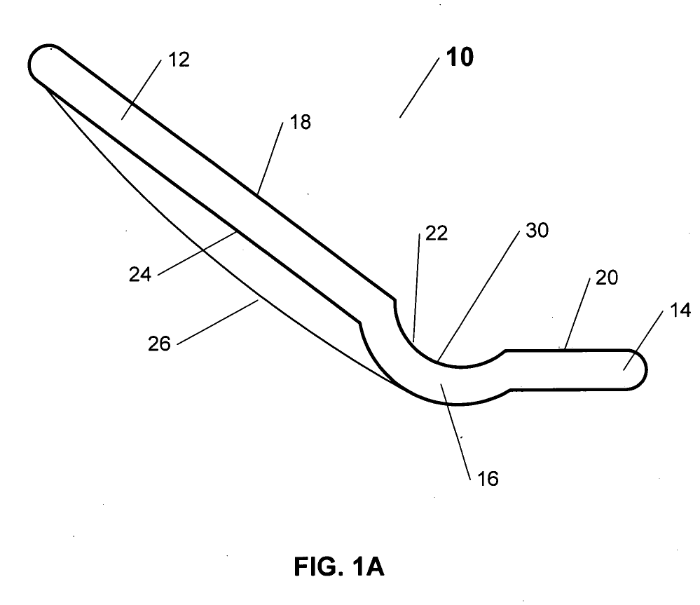

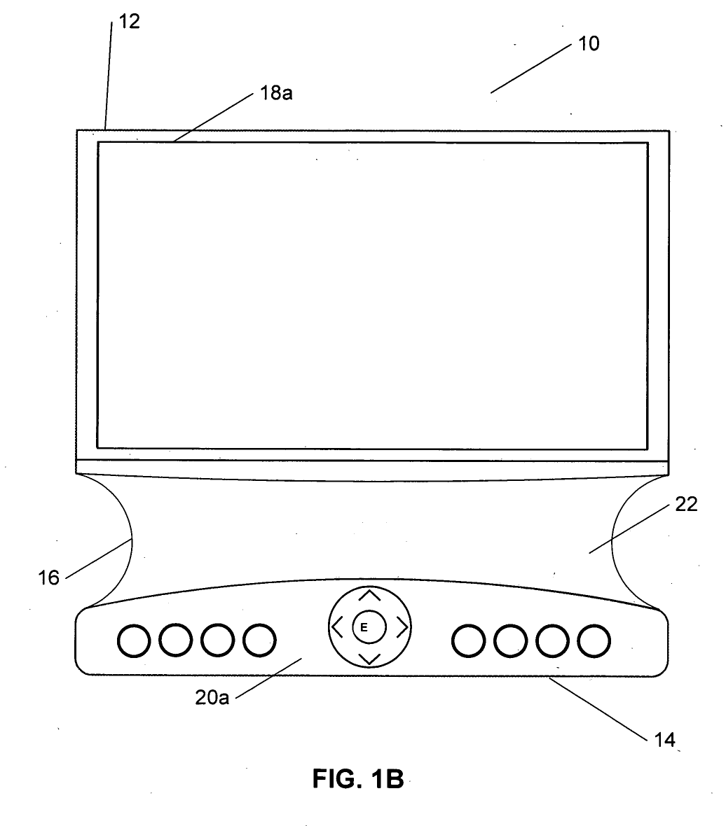

Various exemplary embodiments of the present invention, described below in connection with FIGS. 1-6, show novel features that take advantage of the inventive grasp element to provide additional functionality to the apparatus.

Referring now to FIGS. 1A to 6, the various exemplary embodiments of the inventive ergonomic electronic apparatus are shown. Prior to describing the inventive exemplary embodiments in greater detail, it would be helpful to provide definitions of key terms used in connection with describing the inventive apparatus.
“interface element” means any kind of an input or output that allows a user to issue commands to an electronic device, and/or that enables the user to receive information from the electronic device. By way of example, and without departing from the spirit of the invention, such inputs and outputs may include, but are not limited to: buttons, control pads, touchpads, dials, joysticks, touchscreens, LCD displays, toggles, biometric readers, scanners, sliders, etc. Furthermore, the quantity and exact configuration of the inputs and outputs (such as their size, shape, and position) may be selected as a matter of design choice or convenience without departing from the spirit of the invention.
“device functionality” means one or more functions which an electronic device is designed to perform (such as a remote control for other devices, a PDA, a telephone, a computer, a data acquisition device, etc.)
“operational components” means the physical components of an electronic device that along with an instruction set (for example implemented as software, or other form of programmed capabilities) enable the device to achieve the desired device functionality in response to commands received from the user through one or more of the interface elements, and that enable the device to provide information to the user through one or more appropriate interface element(s) as required by the parameters of the device functionality. Depending on the nature of an electronic device, the operational components thus may include, but are not limited to, circuitry, one or more chipsets, a CPU, memory, data storage, a communication component for enabling any form of optical, sonic, and/or electromagnetic communication (e.g., IR, RF, Wi-Fi, Bluetooth, etc.). One or more of the operational components may also be programmable (in themselves through one or more interface elements or through a connection to a PC), learning, pre-set, or changeable through removable components or parts thereof.

It should also be noted that, as a matter of design choice, depending on the category and desired functionality (remote control, communications device, computer, data collection etc.), of the inventive apparatus, the appropriate interface elements and operational components may be selected to advantageously construct virtually any type of an electronic device, or a combination of electronic devices—whether the device has self-contained functionality, is intended for control of other systems, or both. In addition, the size, and relative size, of the various components of the novel apparatus may be selected as a matter of design choice without departing from the spirit of the invention.

Finally, the below-described FIGS. 1A to 6 illustrate only several of the many possible exemplary configurations of the inventive apparatus. Other contemplated embodiments of the inventive apparatus may include different sized and shaped components (such as the first and second sections and the grasp element) as a matter of convenience and/or design choice. Furthermore, while the various exemplary embodiments of the inventive apparatus are described as having interface regions in both sections of the device, it should be noted that as a matter of convenience, and/or design choice only a single interface region having one or more interface elements therein may be disposed on one of the apparatus sections, and/or the receiving region of the grasp element may also optionally include one or more interface elements.

Referring to FIGS. 1A and 1B, an exemplary embodiment of the inventive apparatus, is shown as an electronic device 10. The device 10 includes a first portion 12 and a second portion 14, with a grasp element 16 positioned therebetween and connected to both portions 12, 14. The portions 12, 14 include corresponding interface regions 18, 20 on their top surfaces facing the user. Each of the interface regions 18, 20 may comprise one or more interface elements. For example, the interface region 18 may include a touchscreen display, while the interface region 20 may include one or more buttons and a direction pad. Optionally, only one of the portions 12, 14 may be configured with interface element(s). The operational components of the device 10 may be housed within one or more of the portions 12, 14, and/or the grasp element 16. Referring to FIG. 1B, by way of example, the interface region 18 is shown as a screen 18a, while the interface region 20 is shown as a collection 20a of buttons and a directional controller.

The grasp element 16 includes a grasp region 22 configured for receiving a user's finger (thumb, etc.). Optionally, the grasp region 22 may be textured and/or coated with. a material to increase the user's comfort and/or to increase traction with the user's finger placed thereon. In an alternate embodiment of the invention, the grasp region 22 may include an interface region 30 with one or more interface elements. Such an arrangement may be useful, if the device functionality requires multiple interface areas. For example, if the device 10 is a game unit, one or two directional controllers may be placed within the interface region 30 for contact with one or both of the user's thumbs.

Optionally, a holding element 26 may be positioned on a rear surface 24 of the section 12, to receive the other fingers of the user's grasping hand when the device 10 is held. The holding element 26 may also serve to stabilize the device 10 when it is placed on a surface, for example for table-top operation thereof. Optionally, the holding element 26 may also be textured and/or coated to increase traction with the user's fingers placed thereon, and with a surface upon which the device 10 may be placed.

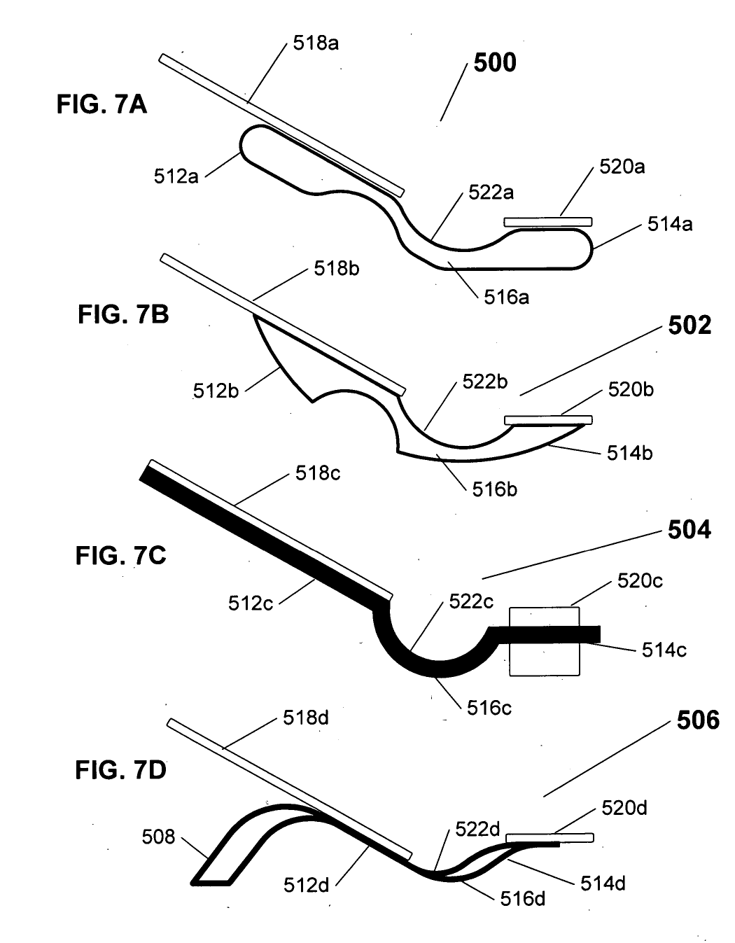

It should be noted that the exact physical configuration, size, shape, and relative position of the various components of the device 10 (i.e., sections 12, 14, grasp element 16, interface regions 18, 20, and grasp element 22) may be selected as a matter of design choice without departing from the spirit of the invention, as long as the components are selected, positioned and configured such that the device 10 is well-balanced when held by the user in one hand, to enable the user to freely use their other hand to interact therewith. Various alternate exemplary embodiments of the device 10, showing just a small example of the variety of component configurations and positions contemplated by the present invention, are shown in FIGS. 7A to 7D.

Referring now to FIGS. 7A to 7D, four exemplary embodiments of the device 10 of FIG. 1 are shown as devices 500, 502, 504, and 506 respectively. The devices 500, 502, 504, and 506, include components 512a-d, 514a-d, 516a-d, 518a-d, 520a-d, and 522a-d, which are generally equivalent to the components 12, 14, 16, 18, 20, and 22 of FIG. 1, respectively. However, the device 506, also includes a stand element 508 which enables the device 506 to be readily stabilized when placed on a flat surface.

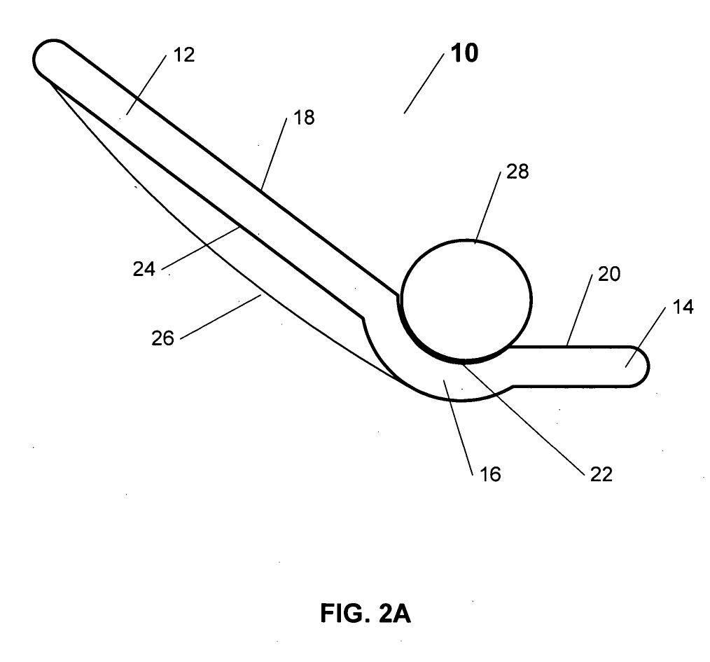

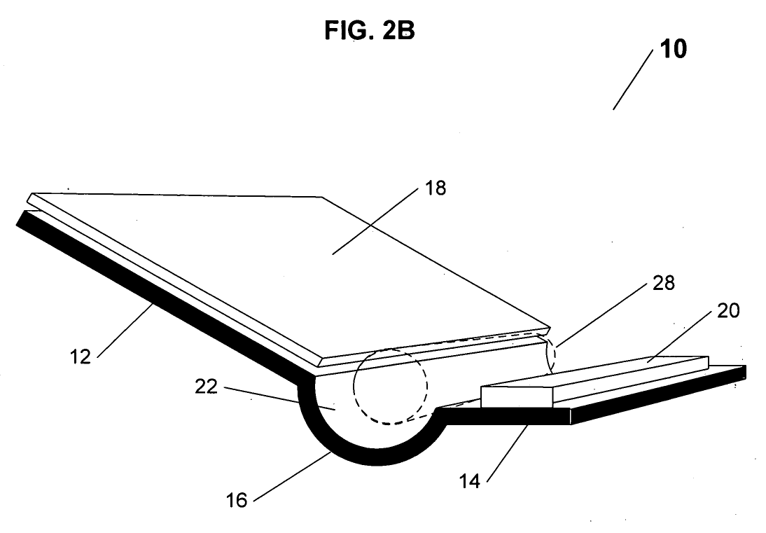

Referring now to FIGS. 2A and 2B, the device 10 may optionally be provided with a functional element 28 that may be placed within the grasp region 22 in such a manner so as to leave enough space for the user to place one of their fingers therein. The functional element 28, which may include one or more components, may be any operational component (or a set of components) that is (are) capable of one or both of the following:
enhancing the device 10 functionality, for example:
   adding new features to the device 10 (e.g., if the functional element 28 provides a new program, a new user interface, etc.),
   expanding the capabilities of the device 10 (e.g., if the functional element 28 provides an additional battery, storage memory, a communication device, etc.), and/or
changing the device 10 functionality (for example, if the functional element provides software and hardware components for converting a home theater remote control device into a personal digital assistant (PDA) or a media player).

In an alternate exemplary embodiment of the device 10, the functional element 28 (or one or more of its components), may be removable from its position in the grasp region 22 (and/or replaceable, by one or more other functional components). In such an embodiment, the functional element 28 may be retained in the grasp region 22 through any releasable attachment technique such as a plug, magnetic force, snap-closure, sliding rail, or any equivalent thereof. In this manner, the functionality and capabilities of the device 10 can be readily changed or upgraded, as may be desired or necessary.

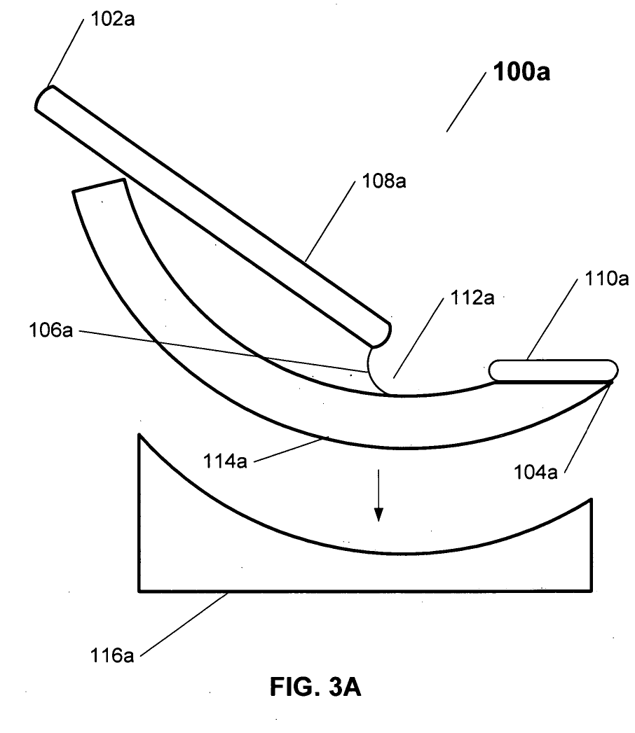

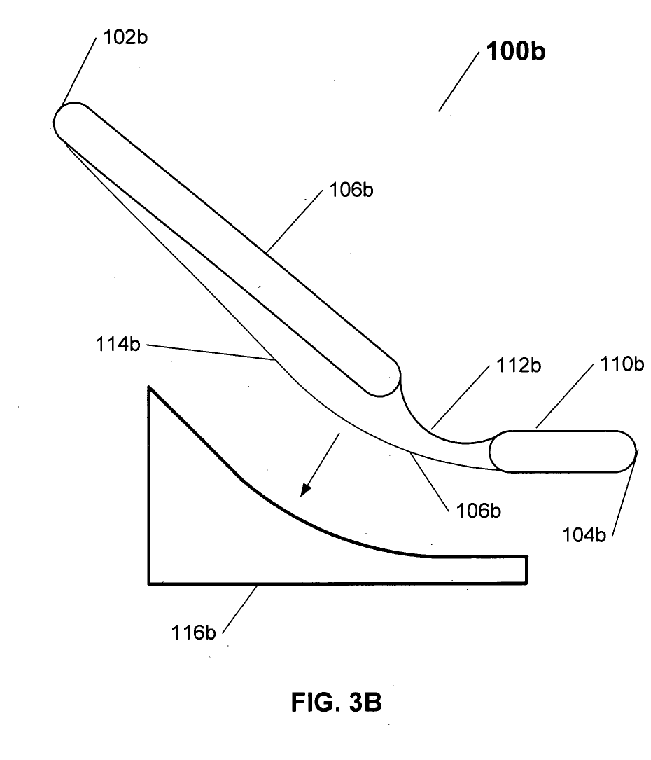

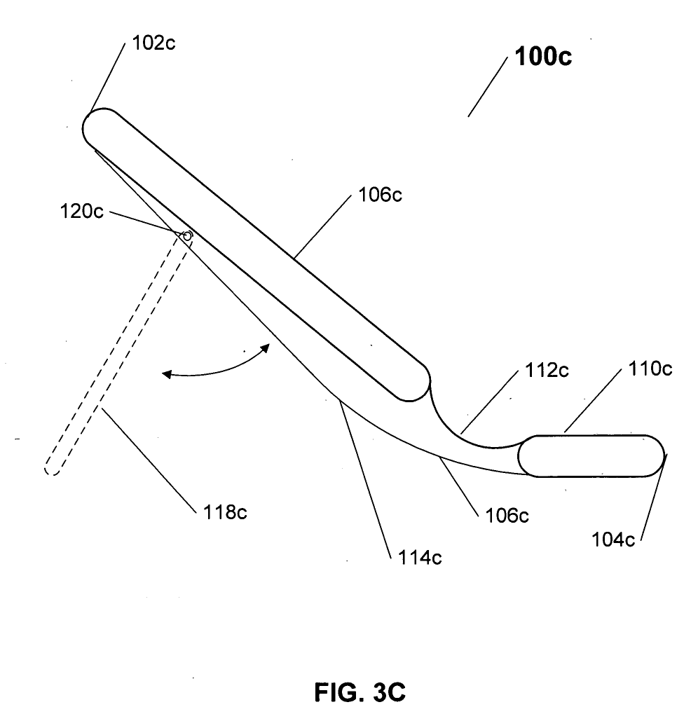

Referring now to FIG. 3A, a second exemplary embodiment of the inventive apparatus is shown as an electronic device 100a. The device 100a is similar to the device 10 of FIGS. 1A-2B, and is provided to illustrate the wide variety in possible contemplated configurations shapes of the novel device sections and the grasp region. Thus, sections 102a, 104a correspond to sections 12, 14 of FIG. 1A, the interface regions 108a and 110a correspond to the regions 18 and 20, the grasp element 106a corresponds to the grasp element 16, while the grasp region 112a corresponds to the grasp region 22. The device 100a is also provided with a holding element 114a that corresponds to the holding element 26 of FIG. 1, abut that is also is sized and configured to fit into a cradle (or other type of support device) 116a. Optionally, if the cradle 116a is correspondingly configured, the holding element 114a may include a connection interface for receiving energy to recharge the device 100a, and/or may include a communication interface to transmit and/or receive data, when the device 100a is placed into the cradle 116a.

Referring to FIG. 3B, an alternate embodiment of the device 100a is shown as an electronic device 100b having an alternate, smaller profile physical configuration. Each of its components 102b to 116b correspond to equivalent components 102ato 116a, except that the holding element 114b is smaller and less pronounced than the element 114a, with a corresponding difference between the cradle 116a and 116b.

Referring now to FIG. 3C, an alternate embodiment of the device 100b of FIG. 3B is shown as electronic device 100c. The device 100c is substantially identical to the device 100b, except that it includes a folding support element 118c that may be pivoted along a pivot 120c. The supporting element 118c preferably folds into the holding element 114c and may be released therefrom if stable positioning of the device 100c is desired on a flat surface outside of the cradle 116b.

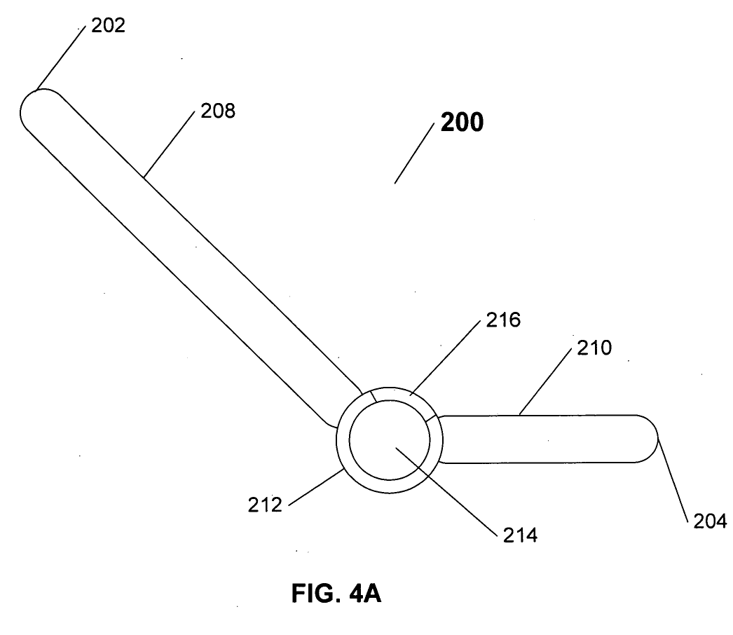

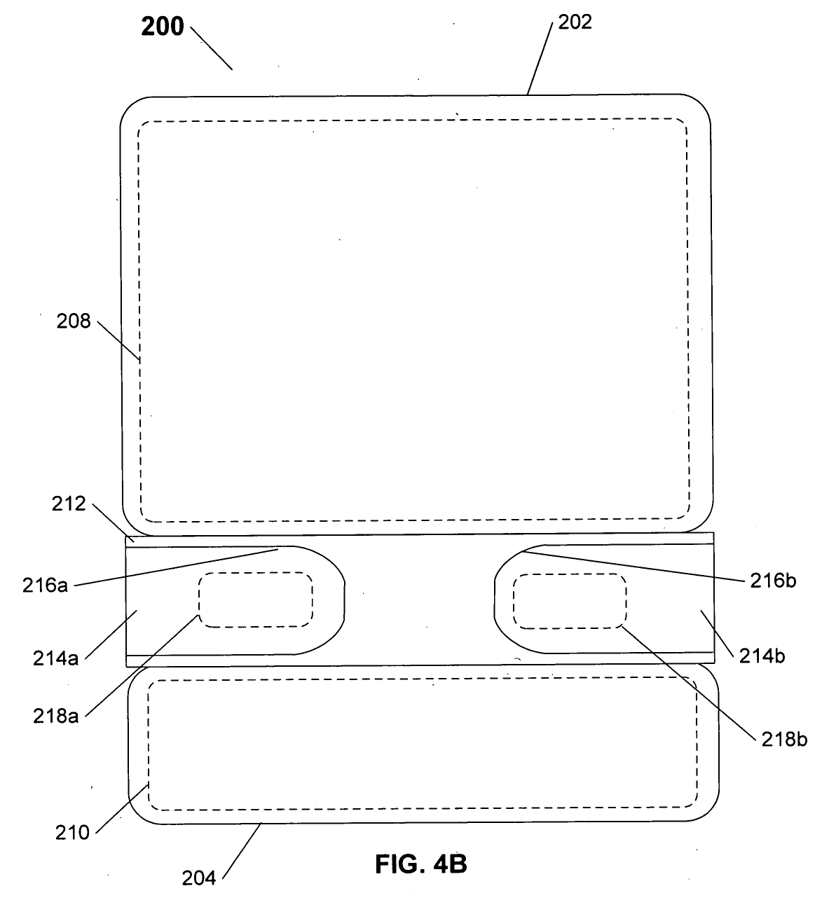

Referring now to FIGS. 4A and 4B, a exemplary third embodiment of the inventive apparatus is shown as an electronic device 200. The device 200 is similar to the device 10 of FIG. 1A except that, a grasp element 212 between the sections 202, 204 (that correspond to the sections 12, 14 of FIG. 1A) serves as a hinge that enables the sections 202, 204 to pivot with respect to one another. Thus, the user is provided with additional capabilities to further improve the ergonomics of the device 200 by adjusting the angle between the sections 202, and 204, and thus reorienting interface regions 208 and 210 (that correspond to interface regions 18, 20 of FIG. 1A) with respect to one another. This feature may prove very helpful in tabletop use, where the angle of the interface region 208 to the user may need to be adjusted to facilitate interaction therewith.

To facilitate the use of a grasp region 214 (corresponding to the grasp region 22 of FIG. 1A), the grasp element 212 may include one or two openings 216, configured to enable the user's finger to pass into the grasp region 214. Referring now to FIG. 4B, optionally, a grasp interface region may be positioned in regions 216a and/or 216b (as described above in connection with optional interface region 30 of FIG. 1A).

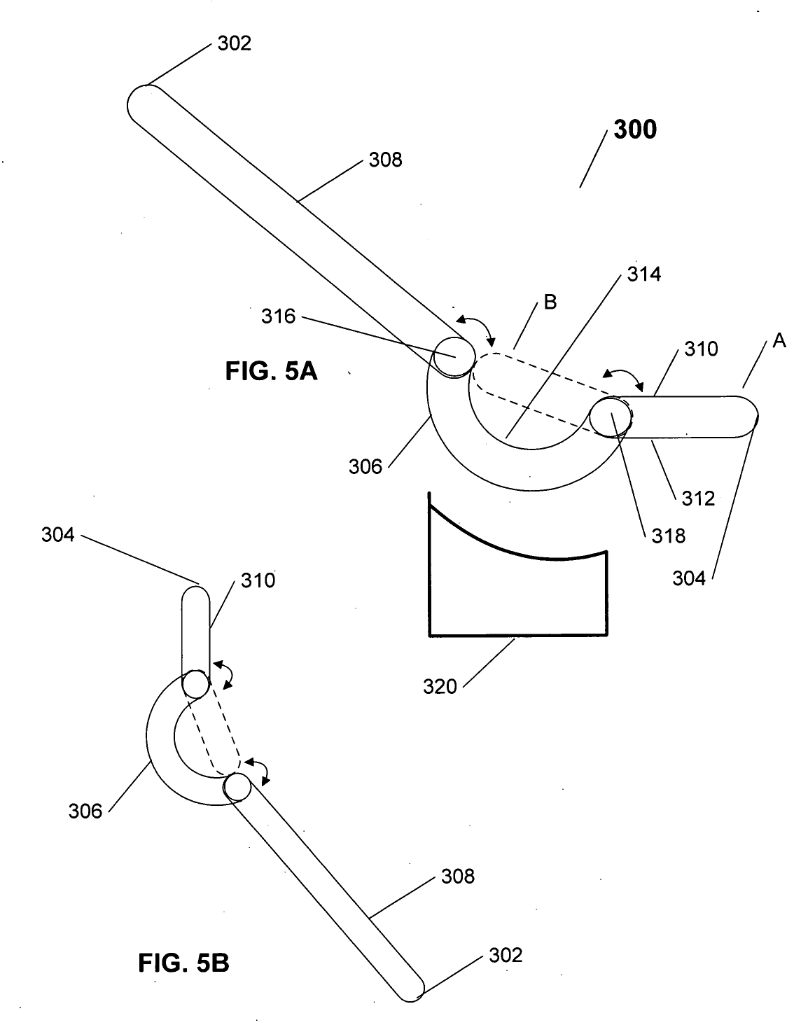

Referring now to FIG. 5A, a fourth embodiment of the inventive apparatus is shown as an electronic device 300. The device 300 is similar to the device 10 of FIGS. 1A-2B, and is provided to illustrate the wide variety in possible contemplated configurations shapes of the novel device sections and the grasp region. Thus, sections 302, 304 correspond to sections 12, 14 of FIG. 1A, the interface regions 308 and 310 correspond to the regions 18 and 20, the grasp element 306 corresponds to the grasp element 16, while the grasp region 314 corresponds to the grasp region 22. The grasp element 306 is preferably sized and configured to fit into a cradle 320 which corresponds to the cradle 116a.

The key difference between the device 300 and the device 10 is that the device 300 is provided with pivot regions 316, 318 along the connections between the grasp element 306, and the respective sections 302, 304. The pivot regions 316, 318 enable the user of the device 300 to independently adjust the angle of each of the sections 302, 304 with respect to the grasp element 306 and one another. Furthermore, if the section 304 is supplied with an additional interface region 312 on a surface opposite to the interface region 310, an additional configuration of the device 300 is possible when the device 300 is placed into the cradle 320, and the section 304 is pivoted from position A to position B, thus exposing the additional interface region 312 to the user. Referring now to FIG. 5B, an alternate orientation of the device 300 is shown with the larger section 302 being below the smaller section 304—a configuration which may be advantageous when a larger interface region is desirable in a lower position.

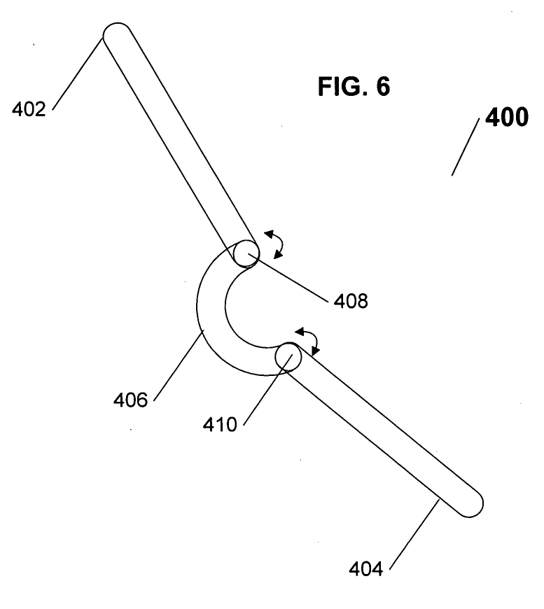

Referring now to FIG. 6, an alternate embodiment of the device 300 is shown as an electronic device 400 having an alternate, physical configuration with two identically sized sections 402 and 404 (corresponding to sections 302 and 304 of FIG. 5A). Similarly, the pivot regions 408, 410 correspond to pivot regions 316, 318, and the grasp element 406 corresponds to the grasp element 306. The device 400 configuration may be of particular use if larger interface regions are required, for example in an electronic device with two screens. As an example, one interface region may be configured as a display screen, while the other region may be configured as a touchscreen, or both interface regions may be configured as touchscreens.

The various embodiments of the novel electronic device described above may be readily utilized in a wide variety of applications, including but not limited to, the following systems and/or components thereof: an audio system, a video system, an audio/video system, a computer system, a data collection system, a home/facility automation system, an industrial process control system, a communication system, an industrial apparatus, a home or commercial appliance, a lighting control system, a security system, a surveillance/monitoring system, a vehicle, a robot, and a weapon system.

Advantageously, the shape and balance of the inventive device enable the user to comfortably hold the device in one hand while maintaining the palm of the hand in a natural slightly bent “self-locking” position. This position is advantageous because it does not require the user to exert any tension to maintain hold on the device. The position of the user's hand encouraged by the shape and balance of the inventive device, enables even larger and heavier embodiments of the novel device to be comfortably held and used for extended periods of time.

Thus, while there have been shown and described and pointed out fundamental novel features of the invention as applied to preferred exemplary embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. An electronic apparatus for performing at least one function in response to interaction with a user, comprising:
a first portion having a first surface and a first back surface;
a second portion having a second surface and a second back surface positioned sequentially below said first portion, said first and second portions having corresponding facing edges therebetween;
a grasp element connected to said corresponding facing edges of both said first and second flat portions, and positioned therebetween, having a hollow grasp region sized and configured to receive at least one of the user's fingers therein, wherein at least one of said first and second surfaces comprises at least one interface element configured for interaction therewith by the user to enable performance of said at least one function, such that the apparatus may be comfortably held by the user in one hand by placing at least one finger in the hollow region, while supporting at least one of said first and second back surfaces with the other fingers, such that the user's other hand may be freely used to interact with said at least one interface element.

2. The electronic apparatus of claim 1, wherein the at least one function comprises interaction, by the user with, at least one additional apparatus.

3. The electronic apparatus of claim 2, wherein said at least one additional apparatus comprises at least one of the following systems and/or components thereof: an audio system, a video system, an audio/video system, a computer system, a data collection system, a home/facility automation system, an industrial process control system, a communication system, an industrial apparatus, a home or commercial appliance, a lighting control system, a security system, a surveillance/monitoring system, a vehicle, a robot, and a weapon system.

4. The electronic apparatus of claim 2, wherein said interaction comprises utilization of said at least one interface element by the user to at least one of: issue at least one instruction by the user to said at least one additional apparatus, and receiving, by the electronic apparatus, at least one data item therefrom.

5. The electronic apparatus of claim 1, wherein the electronic apparatus is further operable to perform at least one task, wherein the at least one function comprises performing said at least one task by the electronic apparatus, and wherein said interaction comprises utilization of said at least one interface element by the user to cause the electronic apparatus to perform said at least one task.

6. The electronic apparatus of claim 1, wherein said grasp region comprises at least one additional interface element configured for interaction therewith by the user to enable performance of said at least one function.

7. The electronic apparatus of claim 1, further comprising at least one additional device component positioned within said grasp region, operable to alter the apparatus.

8. The electronic apparatus of claim 7, wherein said at least one additional device component is operable to achieve at least one of the following: enhance said at least one function of the apparatus, change said at least one function of the apparatus, add at least one additional function to the apparatus.

9. The electronic apparatus of claim 7, wherein at least one of the apparatus and said at least one additional device component comprise a releasable attachment device operable to releasably attach said at least one additional device component to said grasp region.

10. The electronic apparatus of claim 1, wherein said grasp element comprises at least one pivot element operable to change an angular position of at least one of said first and second portions with respect to one another.

11. The electronic apparatus of claim 1, further comprising a separate support element sized and configured to support the apparatus when said support element is positioned on a flat surface and the apparatus is placed thereon.

12. The electronic apparatus of claim 10, wherein said support element comprises a support component operable to provide at least one supporting function to the apparatus.

13. The electronic apparatus of claim 11, wherein said at least one supporting function is selected from a following group: providing at least one additional device function, providing power to recharge the apparatus, and providing communication capabilities to the apparatus.

14. The electronic apparatus of claim 1, further comprising a support element operable to retain the apparatus in a predetermined stable position, when the apparatus is placed on a substantially flat surface.

15. The electronic apparatus of claim 14, wherein said support element comprises means for changing the position of said support element, such that the support element does not interfere with the user's hand when the apparatus is held by the user.

16. The electronic apparatus of claim 10, wherein said second back surface of said second portion comprises at least one additional interface element configured for interaction therewith by the user to enable performance of said at least one function, and wherein said at least one pivot element comprises a first pivot element, positioned between said grasp element and said second portion, operable to pivot said second portion with respect to said grasp element sufficiently to position said at least one additional interface element for interaction by the user holding the apparatus.

17. The electronic apparatus of claim 1, wherein relative sizes of said first and second portions are selected from the following group: said first potion larger than said second portion, said second portion larger than said first portion, and said first and second portions being substantially equal in size.

18. The electronic apparatus of claim 1, further comprising a holding element, positioned along at least one of said first and second back surfaces, operable to enhance the comfort of the user holding the apparatus.

19. The electronic apparatus of claim 18, wherein said holding element is further operable to retain the apparatus in a predetermined stable position, when the apparatus is placed on a substantially flat surface.
